(19) United States
(12) Patent Application Publication
(10) Pub. No.: US 2009/0132372 A1
(43) Pub. Date: May 21, 2009

(54) METHOD FOR CALCULATING PREDICTED CHARGE AMOUNT OF ADVERTISEMENT FOR EACH KEYWORD AND SYSTEM FOR EXECUTING THE METHOD

(75) Inventor: Ki Ho SONG, Seoul (KR)

Correspondence Address: EDWARDS ANGELL PALMER & DODGE LLP, P.O. BOX 55874, BOSTON, MA, 02205, US

(73) Assignee: NHN CORPORATION, Seongnam (KR)

(21) Appl. No.: 12/274,512

(22) Filed: Nov. 20, 2008

(30) Foreign Application Priority Data
Nov. 20, 2007 (KR) 10-2007-0118649

(51) Int. Cl. G06Q 30/00

(52) U.S. Cl. 705/14

(57) ABSTRACT

A method of calculating a predicted charge amount of an advertisement of a keyword or keywords that an advertiser can purchase for keyword advertising and a system for executing method are provided. The method includes: calculating a first variable based on a standard deviation of daily charge amounts of the advertisement and a maximum daily charge amount; calculating a second variable based on the first variable, the standard deviation, and an average daily charge amount; and calculating a predicted charge amount range based on the first variable and the second variable.

### CROSS-REFERENCE TO RELATED APPLICATION

This application claims the benefit of Korean Patent Application No. 10-2007-0118649, filed on Nov. 20, 2007, the entire disclosure of which is incorporated herein by reference.

### BACKGROUND

1. Technical Field

The present disclosure relates to a method of calculating a predicted charge amount of an advertisement for each keyword and a system for executing the method.

2. Background Art

Keyword advertisement denotes a type of advertisement that is configured to display a particular advertisement in a search result page when a keyword a user inputs to search a desired advertisement is matched with a keyword an advertiser purchases. For example, when a user enters the term “moving” as a keyword, advertisements associated with “packing and moving,” “moving company,” and the like are retrieved. In this instance, in an aspect that such advertisements are displayed for only a person interested in that particular service item, the keyword advertisement is different from banner advertisement. That is, since the advertisement is exhibited only for the person that has interest in a particular product or service item, targeted advertisement is possible and a click rate can be increased. The keyword advertisement includes a cost-per-click (CPC) advertisement and a cost-per-mill (CPM) advertisement.

In conventional keyword advertisements, a ranking of advertisement is determined merely based on a bid amount set for each of various advertisement regions and a corresponding advertisement is displayed according to the ranking. The conventional keyword advertisements, however, have a problem in that when an advertiser desires to register the CPC advertisement, the advertiser may not reasonably predict an advertisement budget. In particular, in the case of a payment scheme of charging a predetermined amount of money in advance and subtracting advertisement cost from the charged amount of money, it may be difficult for the advertiser to predict how much money to allocate.

The above information disclosed in this Background section is only for enhancement of understanding of the background of the invention and therefore it may contain information that does not form the prior art that is already known in this country to a person of ordinary skill in the art.

### BRIEF SUMMARY

According to an aspect of the present invention, there is provided a method of providing a predicted charge amount of an advertisement corresponding to a keyword or keywords that an advertiser can purchase for keyword advertising, the method comprising: calculating a first variable based on a standard deviation of daily charge amounts of an advertisement corresponding to each keyword and a maximum daily charge amount; calculating a second variable based on the first variable, the standard deviation, and an average daily charge amount; and calculating a predicted charge amount range based on the first variable and the second variable.

Another aspect of the invention provides a method of providing a predicted charge amount of an advertisement corresponding to a keyword or keywords that an advertiser can purchase for keyword advertising, the method comprising: calculating a minimum predicted charge amount in a charge amount range of the previous day on the basis of a weight of a standard deviation of daily charge amounts of an advertisement corresponding to each keyword to a maximum daily charge amount of the daily charge amounts; calculating a maximum predicted charge amount in the charge amount range of the previous day on the basis of a weight of the standard deviation to an average daily charge amount; and determining, as a predicted charge amount range, a range by the minimum predicted charge amount and the maximum predicted charge amount.

Still another aspect of the invention provides a computer-readable recording medium storing a program for implementing the methods.

A further aspect of the invention provides a system for providing a predicted charge amount of an advertisement corresponding to a keyword or keywords that an advertiser can purchase for keyword advertising, the system comprising: a first variable calculating module to calculate a first variable based on a standard deviation of daily charge amounts of an advertisement corresponding to each keyword and a maximum daily charge amount of the daily charge amounts; a second variable calculating module to calculate a second variable based on the first variable, the standard deviation, and an average daily charge amount; and a predicted charge amount range calculating module to calculate a predicted charge amount range based on the first variable and the second variable.

The above and other aspects and features of the invention are discussed infra.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a predicted charge amount calculating system according to an embodiment of the present invention;

FIG. 2 is a web page illustrating an example of an advertisement registration site displaying a predicted charge amount range according to an embodiment of the present invention;

FIG. 3 is a flowchart illustrating a method of calculating a predicted charge amount according to an embodiment of the present invention;

FIG. 4 is a flowchart illustrating a method of calculating a ratio of a standard deviation to a maximum daily charge amount according to an embodiment of the present invention;

FIG. 5 is a flowchart illustrating a method of calculating a ratio of a standard deviation to an average daily charge amount according to an embodiment of the present invention;

FIG. 6 is a block diagram illustrating an exemplary configuration of a predicted charge amount calculating system according to an embodiment of the present invention; and

FIG. 7 is a flowchart illustrating a method of calculating a predicted charge amount according to another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout.

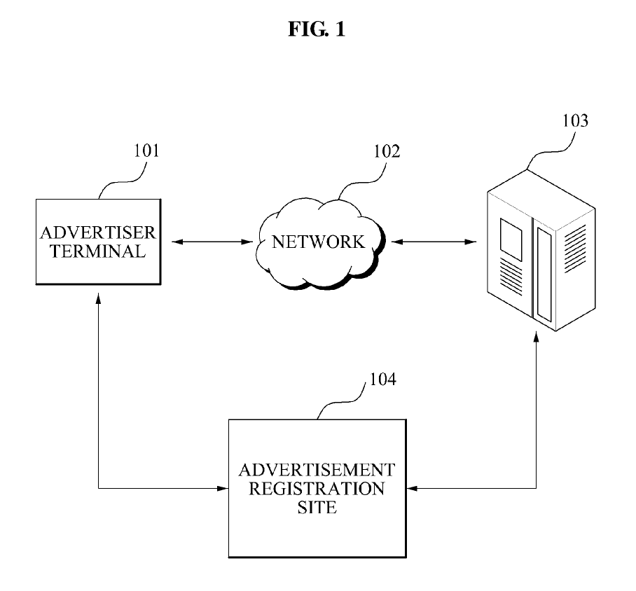

FIG. 1 illustrates a predicted charge amount calculating system 103 according to an embodiment of the present invention.

An advertiser may access the predicted charge amount calculating system 103 via an advertiser terminal 101 and a network 102. The predicted charge amount calculating system 103 may be provided in various ways. For example, it may be provided such as to interoperate with an advertisement registration system for registering advertisements, or may be included in the advertisement registration system.

Specifically, the predicted charge amount calculating system 103 may determine a predicted charge amount range for each keyword and display the determined predicted charge amount range via an advertisement registration site 104. When the advertiser accesses the advertisement registration site 104 via the advertisement registration system to purchase a keyword for registering the advertiser's advertisement, the advertiser may more reasonably determine an advertisement budget for the keyword by referring to the predicted charge amount range.

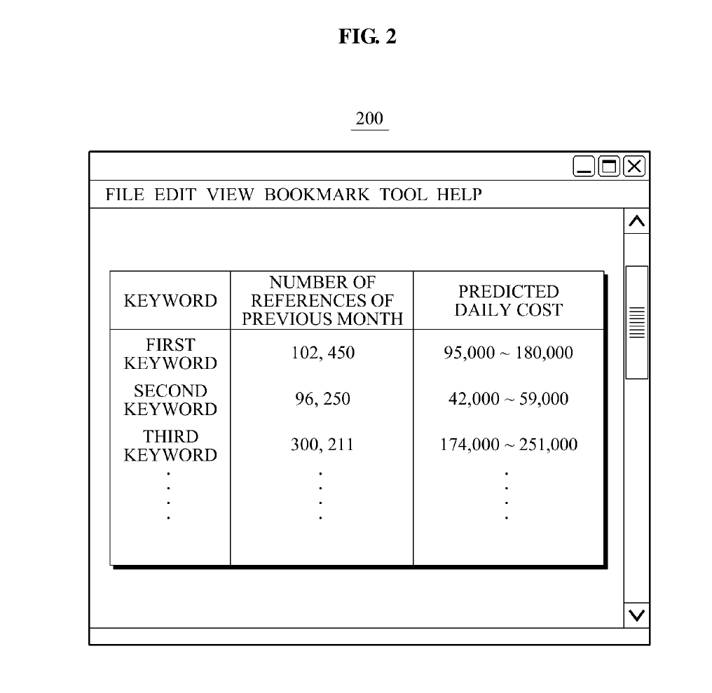

FIG. 2 is a web page 200 illustrating an example of an advertisement registration site displaying a predicted charge amount range according to an embodiment of the present invention. The web page 200, among pages of the advertisement registration site, functions to, e.g., provide an estimate with respect to a corresponding keyword. Specifically, in addition to the number of references of the previous month by which an advertiser can predict the effect of a purchased keyword, the web page 200 may provide the predicted charge amount range for a predicted daily cost. Accordingly, an advertiser that desires to register a keyword advertisement may easily understand the effect of a keyword that the advertiser desires to purchase and an advertisement budget based on the purchased keyword. Here, the web page 200 is an example provided solely for facilitating general understanding of the present invention and thus an interface for displaying the predicted charge amount range is not limited to the web page 200. It will be apparent to those skilled in the art that various modifications and changes may be made from the description.

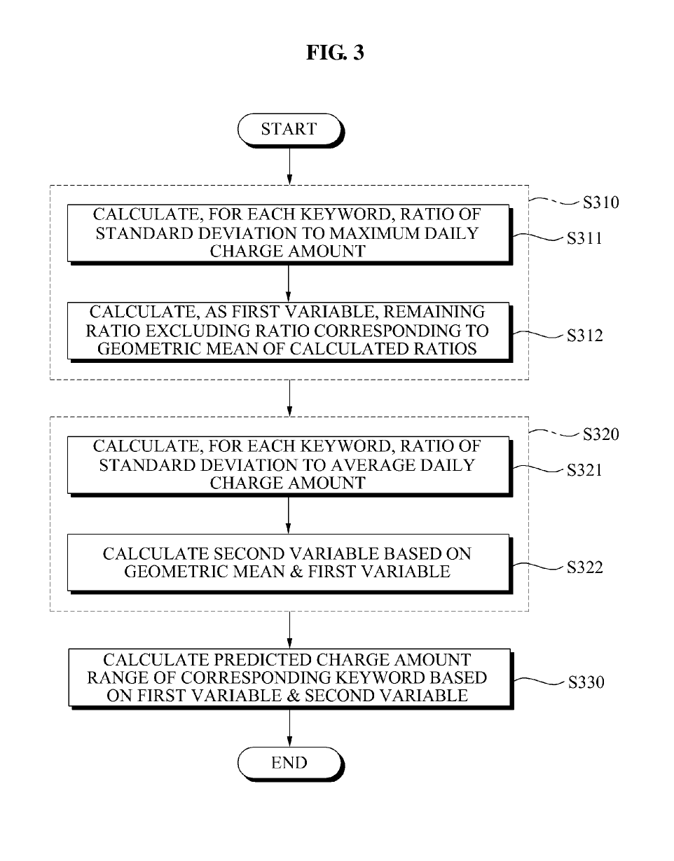

FIG. 3 is a flowchart illustrating a method of calculating a predicted charge amount according to an embodiment of the present invention.

In operation S310, a predicted charge amount calculating system calculates a first variable based on a maximum daily charge amount and a standard deviation of daily charge amounts. The daily charge amounts may be charge amounts of the previous day of an advertisement. The daily charge amount may be calculated based on at least one of a quality index, a ranking index, a number of clicks, and a cost per click (CPC) with respect to a corresponding advertisement.

The quality index may be calculated based on a quality factor corresponding to a pre-evaluation element and a Click-Through Rate (CTR) corresponding to a post evaluation element with respect to the advertisement. For example, the quality index may be calculated by adding up the quality factor and the CTR assigned with respective weights. The quality factor may be measured based on at least one of Title & Description (T&D) score associated with the advertisement, a site authority, and a site score. Herein, the elements used for measuring the quality factor are not limited to the T&D score, the site authority, and the site score. Other indexes that are previously evaluated by analyzing a pattern of a user may be used.

The ranking index may be calculated based on the quality index and a maximum click cost. The maximum click cost may denote a maximum cost per click that an advertiser is willing to pay when the advertisement registered is clicked on.

As discussed above, the predicted charge amount calculating system may calculate the first variable based on the standard deviation of daily charge amounts and the maximum daily charge amount. For this, the predicted charge amount calculating system may perform operations S311 and S312 of FIG. 3.

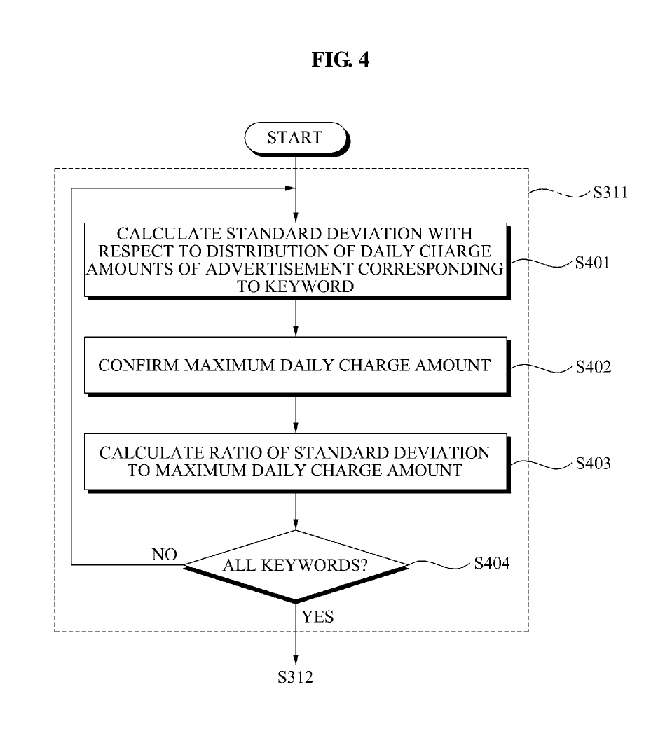

In operation S311, the predicted charge amount calculating system calculates, for each keyword, a ratio of the standard deviation to the maximum daily charge amount. In this instance, the predicted charge amount calculating system may calculate the respective ratios for all the keywords. A method of calculating the ratio for each keyword will be described in detail with reference to FIG. 4.

In operation S312, the predicted charge amount calculating system calculates the first variable by subtracting a ratio corresponding to the geometric mean of the calculated ratios from “1”. In other words, the predicted charge amount calculating system may calculate the geometric mean of the ratios calculated for all the keywords and exclude the geometric mean from “1” and thereby may calculate the remaining ratio as the first variable. In this instance, the geometric mean and the first variable may independently have a value between “0” and “1.”

In operation S320, the predicted charge amount calculating system calculates a second variable based on the first variable, the standard deviation, and an average daily charge amount. Here, the predicted charge amount calculating system may calculate, for each keyword, the standard deviation of daily charge amounts and the average daily charge amount and calculate the second variable based on a ratio of the standard deviation to the average daily charge amount. For this, the predicted charge amount calculating system may perform operations S321 and S322.

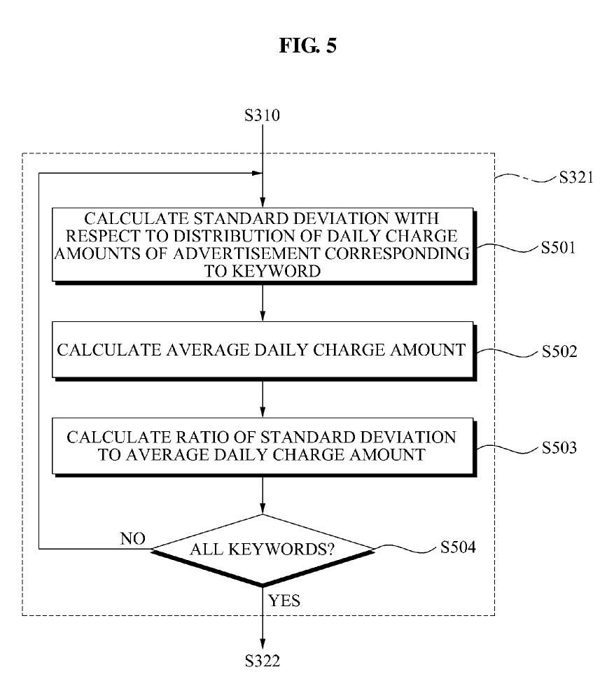

In operation S321, the predicted charge amount calculating system calculates, for each keyword, the ratio of the standard deviation to the average daily charge amount. Specifically, the predicted charge amount calculating system may confirm daily charge amounts of a corresponding advertisement for each keyword, calculate the standard deviation of the daily charge amounts, and calculate, for each keyword, the average daily charge amount. Through this, the predicted charge amount calculating system may calculate the ratios for all of the keywords. Operation S321 will be further described in detail with reference to FIG. 5.

In operation S322, the predicted charge amount calculating system calculates the second variable based on the geometric mean of the calculated ratios and the first variable. For example, the predicted charge amount calculating system may calculate a sum of the geometric mean and the first variable as the second variable.

In operation S330, the predicted charge amount calculating system calculates a predicted charge amount range of a corresponding keyword based on the first variable and the second variable. In this instance, the predicted charge amount calculating system may calculate a minimum predicted charge amount based on the daily charge amount range of the keyword and the first variable. The daily charge amount range may be determined based on a minimum daily charge amount and a maximum daily charge amount among daily charge amounts of an advertisement corresponding to the keyword. The predicted charge amount calculating system may calculate, as the minimum predicted charge amount, a percentile value corresponding to the first variable in the daily charge amount range. For example, when the first variable is “0.6,” the minimum predicted charge amount may be a 60th percentile value in the daily charge amount range, which may be, e.g., charge amounts of the previous day of advertisements of the keyword.

Also, the predicted charge amount calculating system may calculate a maximum predicted charge amount based on the second variable and the maximum daily charge amount of the keyword. For example, the maximum predicted charge amount may be calculated by multiplying the maximum daily charge amount and the second variable.

The predicted charge amount range may be determined based on the minimum predicted charge amount and the maximum predicted charge amount. As described above, the determined predicted charge amount range may be displayed for advertisers via an advertisement registration site and the like. The advertisers may use the predicted charge amount range as a suitable guide when they calculate their advertisement budget.

In order to reduce the amount of calculation, the predicted charge amount calculating system may temporarily store a standard deviation calculated in one operation and use the standard deviation in another operation. It may be applicable to operations that may be included in operations S311 and S321 and thereby be performed through operations illustrated in FIGS. 4 and 5. Also, the predicted charge amount calculating system may use at least one of a first variable and a second variable initially calculated in a subsequent operation or operations or may recalculate at least one of the variables at a predetermined period of time.

FIG. 4 is a flowchart illustrating a method of calculating a ratio of a standard deviation to a maximum daily charge amount according to an embodiment of the present invention. Here, operations S401 through S404 may be included in operation S311 of FIG. 3.

In operation S401, the predicted charge amount calculating system calculates the standard deviation of daily charge amounts of an advertisement corresponding to a keyword. A plurality of advertisements may be registered in association with a single keyword. Accordingly, the predicted charge amount calculating system may confirm daily charge amounts of each advertisement corresponding to the keyword and calculate the standard deviation based on the distribution of the daily charge amounts.

In operation S402, the predicted charge amount calculating system confirms the maximum daily charge amount among the daily charge amounts. The maximum daily charge amount may denote a daily charge amount of an advertisement that has the highest charged amount among the advertisements in the previous day.

In operation S403, the predicted charge amount calculating system calculates a ratio of the standard deviation to the maximum daily charge amount. For example, the predicted charge amount calculating system may calculate the ratio by dividing the standard deviation by the maximum daily charge amount.

In operation S404, the predicted charge amount calculating system repeats operations S401 through S403 with respect to all the keywords. Specifically, when the ratio of the standard deviation to the maximum daily charge amount is not calculated with respect to all the keywords, the predicted charge amount calculating system may again perform operation S401. Otherwise, the predicted charge amount calculating system may perform operation S312.

As described above, the predicted charge amount calculating system may calculate the respective ratios of the respective standard deviations to the respective maximum daily charge amounts for all the keywords via operations S401 through S404. In operation S312, the predicted charge amount calculating system may calculate the first variable based on the geometric mean of the calculated ratios.

FIG. 5 is a flowchart illustrating a method of calculating a ratio of a standard deviation to an average daily charge amount according to an embodiment of the present invention. As shown in FIG. 5, operations S501 through S504 may be included in operation S321 of FIG. 3.

In operation S501, the predicted charge amount calculating system calculates the standard deviation of daily charge amounts of an advertisement corresponding to a keyword. In this instance, as described above, instead of re-calculating the standard deviation, an existing calculated standard deviation may be used.

In operation S502, the predicted charge amount calculating system calculates the average daily charge amount of the daily charge amounts. In this case, the average value of the daily charge amounts of advertisements may be used as the average daily charge amount.

In operation S503, the predicted charge amount calculating system calculates a ratio of the standard deviation to the average daily charge amount. For example, the predicted charge amount calculating system may calculate the ratio by dividing the standard deviation by the average daily charge amount.

In operation S504, the predicted charge amount calculating system repeats operations S501 through S503 with respect to all the keywords. Specifically, when the ratio of the standard deviation to the average daily charge amount is not calculated with respect to all the keywords, the predicted charge amount calculating system may again perform operation S501. Otherwise, the predicted charge amount calculating system may perform operation S322.

Similarly, the predicted charge amount calculating system may calculate the respective ratios of the respective standard deviations to the respective average daily charge amounts for all the keywords. The predicted charge amount calculating system may calculate the second variable based on the calculated ratios and the first variable.

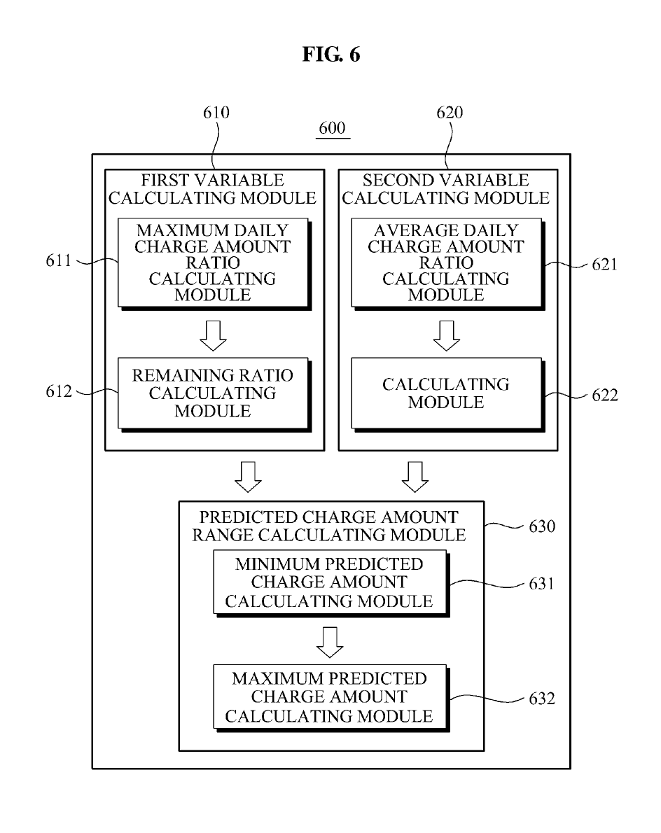

FIG. 6 is a block diagram illustrating an internal configuration of a predicted charge amount calculating system 600 according to an embodiment of the present invention. As shown in FIG. 6, the predicted charge amount calculating system 600 includes a first variable calculating module 610, a second variable calculating module 620, and a predicted charge amount range calculating module 630.

The first variable calculating module 610 functions to calculate a first variable based on a maximum daily charge amount and a standard deviation of daily charge amounts. The daily charge amounts may be charge amounts of the previous day of an advertisement. In this case, the daily charge amount may be calculated based on at least one of a quality index, a ranking index, a number of clicks, and a CPC with respect to a corresponding advertisement.

Specifically, the first variable calculating module 610 may calculate the first variable based on the standard deviation of daily charge amounts and the maximum daily charge amount among the daily charge amounts. For this, the first variable calculating module 610 may include a maximum daily charge amount ratio calculating module 611 and a remaining ratio calculating module 612.

The maximum daily charge amount ratio calculating module 611 functions to calculate, for each keyword, a ratio of the standard deviation to the maximum daily charge amount. Specifically, the maximum daily charge amount ratio calculating module 611 may calculate the standard deviation of daily charge amounts of an advertisement corresponding to a keyword, confirm the maximum daily charge amount among the daily charge amounts, and calculate a ratio of the standard deviation to the maximum daily charge amount with respect to the keyword. Through the above scheme, the maximum daily charge amount ratio calculating module 611 may calculate the respective ratios with respect to all the keywords.

The remaining ratio calculating module 612 functions to calculate, as the first variable, the remaining ratio after subtracting a ratio corresponding to the geometric mean of the calculated ratios from “1”. In other words, the remaining ratio calculating module 612 may calculate the geometric mean of the ratios calculated for all the keywords and exclude the geometric mean from “1” and thereby may calculate the remaining ratio as the first variable. In this instance, the geometric mean and the first variable may independently have a value between “0” and “1.”

The second variable calculating module 620 functions to calculate a second variable based on the first variable, the standard deviation, and an average daily charge amount. Here, the second variable calculating module 620 may calculate, for each keyword, the standard deviation of daily charge amounts and the average daily charge amount and calculate the second variable based on a ratio of the standard deviation to the average daily charge amount. For this, the second variable calculating module 620 may include an average daily charge amount ratio calculating module 621 and a calculating module 622.

The average daily charge amount ratio calculating module 621 functions to calculate, for each keyword, the ratio of the standard deviation to the average daily charge amount. Specifically, the average daily charge amount ratio calculating module 621 may confirm daily charge amounts of a corresponding advertisement for each keyword, calculate the standard deviation of the daily charge amounts, and calculate, for each keyword, the average daily charge amount. Through this, the average daily charge amount ratio calculating module 621 may calculate the ratios for all of the keywords. More specifically, the average daily charge amount ratio calculating module 621 may calculate the standard deviation of daily charge amounts of an advertisement corresponding to a predetermined keyword, calculate an average daily charge amount of the daily charge amounts, and calculate a ratio of the standard deviation to the average daily charge amount. In this instance, the average daily charge amount may denote the average value of daily charge amounts of advertisements. In the same process, the average daily charge amount ratio calculating module 621 may calculate the ratios for all the keywords.

The calculating module 622 functions to calculate the second variable based on the geometric mean of the calculated ratios and the first variable. For example, the calculating module 622 may calculate a sum of the geometric mean and the first variable as the second variable.

In order to reduce the amount of calculation, the standard deviation may be calculated by only one of the maximum daily charge amount ratio calculating module 611 and the average daily charge amount ratio calculating module 621. For example, when the standard deviation is calculated by the maximum daily charge amount ratio calculating module 611, the predicted charge amount calculating system 600 may temporarily store the calculated standard deviation. When the standard deviation is required by the average daily charge amount ratio calculating module 621, the predicted charge amount calculating system 600 may enable the average daily charge amount ratio calculating module 621 to use the temporarily stored standard deviation as is without a need for a repetitive calculation thereof.

The predicted charge amount range calculating module 630 functions to calculate a predicted charge amount range of a corresponding keyword based on the first variable and the second variable. For this, the predicted charge amount range calculating module 630 may include a minimum predicted charge amount calculating module 631 and a maximum predicted charge amount calculating module 632. In this instance, the minimum predicted charge amount calculating module 631 may calculate a minimum predicted charge amount based on the daily charge amount range of the keyword and the first variable. The daily charge amount range may be determined based on a minimum daily charge amount and a maximum daily charge amount among daily charge amounts of an advertisement corresponding to the keyword. The minimum predicted charge amount calculating module 631 may calculate, as the minimum predicted charge amount, a percentile value corresponding to the first variable in the daily charge amount range. For example, when the first variable is “0.6,” the minimum predicted charge amount may be a 60th percentile value in the daily charge amount range, which may be, e.g., charge amounts of the previous day of advertisements of the keyword.

Also, the maximum predicted charge amount calculating module 632 may calculate a maximum predicted charge amount based on the second variable and the maximum daily charge amount of the keyword. For example, the maximum predicted charge amount may be calculated by multiplying the maximum daily charge amount and the second variable.

The predicted charge amount range may be determined based on the minimum predicted charge amount and the maximum predicted charge amount. As described above, the determined predicted charge amount range may be displayed for advertisers via an advertisement registration site and the like. The advertisers may use the predicted charge amount range as a suitable guide when they calculate their advertisement budget.

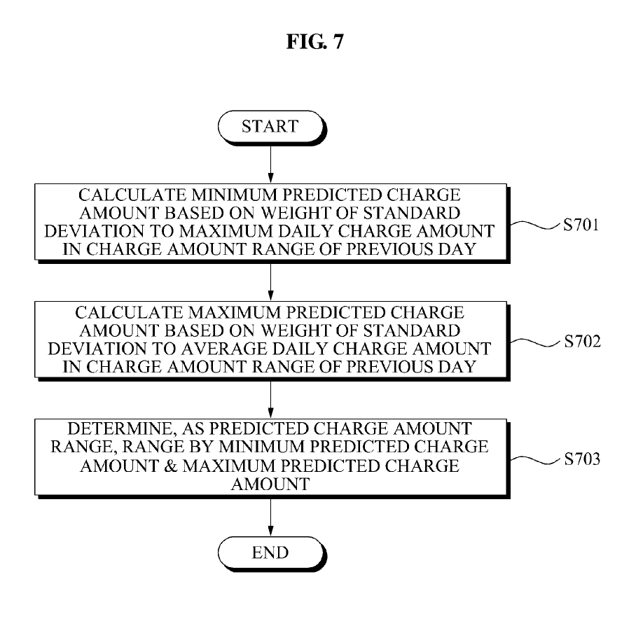

FIG. 7 is a flowchart illustrating a method of calculating a predicted charge amount according to another embodiment of the present invention.

In operation S701, a predicted charge amount calculating system for determining a predicted charge amount range for a keyword calculates a minimum predicted charge amount based on a weight of a standard deviation to a maximum daily charge amount in a charge amount range of the previous day. Specifically, the predicted charge amount calculating system may calculate the weight based on the maximum daily charge amount for each keyword and the standard deviation of daily charge amounts for each keyword, and determine, as the minimum predicted charge amount, a percentile value corresponding to the weight in the charge amount range of the previous day.

In order to calculate the weight of the standard deviation to the maximum daily charge amount, the predicted charge amount calculating system may calculate, for each keyword, the standard deviation of daily charge amounts of a corresponding advertisement or may confirm the standard deviation calculated in operation S701, confirm the maximum daily charge amount among the daily charge amounts, calculate, for each keyword, a ratio of the standard deviation to the maximum daily charge, and then calculate, as the weight of the standard deviation to the maximum daily charge amount, the remaining ratio after subtracting a ratio corresponding to the geometric mean of the calculated ratios from “1”. Here, the daily charge amount may denote the charge amount of the previous day of the advertisement. In this case, the daily charge amount may be calculated based on at least one of a quality index, a ranking index, a number of clicks, and a CPC.

In operation S702, the predicted charge amount calculating system calculates a maximum predicted charge amount based on a weight of the standard deviation to an average daily charge amount in the charge amount range of the previous day. Specifically, the predicted charge amount calculating system may calculate the weight based on the average daily charge amount for each keyword and the standard deviation of daily charge amounts for each keyword, and may calculate, as the maximum predicted charge amount, an operation result between a maximum charge amount in the charge amount range of the previous day and the weight of the standard deviation to the average daily charge amount.

In order to calculate the weight of the standard deviation to the average daily charge amount, the predicted charge amount calculating system may calculate, for each keyword, the standard deviation of daily charge amounts of a corresponding advertising list, confirm the average daily charge amount among the daily charge amounts, calculate, for each keyword, a ratio of the standard deviation to the average daily charge amount, and then calculate the weight of the standard deviation to the average daily charge amount based on the weight of the standard deviation to the maximum daily charge amount and the calculated ratios.

In operation S703, the predicted charge amount calculating system determines, as a predicted charge amount range, a range by the minimum predicted charge amount and the maximum predicted charge amount. The calculated predicted charge amount range may be displayed for advertisers via an advertisement registration site and the like. Thus, the advertisers may more accurately set their own advertisement budget by referring to the displayed predicted charge amount range.

According to the embodiments of the present invention, when an advertiser registers an advertisement, or when a telemarketer registers an advertisement using a sales tool, a predicted charge amount range for the advertisement may be provided. Through this, a suitable guide may be provided for the advertiser or the telemarketer to be able to set a reasonable advertisement budget.

According to the embodiments of the present invention, by calculating a minimum predicted charge amount and a maximum predicted charge amount based on the actual charge amount range of the previous day and by displaying the predicted charge amount range that is determined based on the minimum predicted charge amount and the maximum predicted charge amount, it may be possible to encourage a purchase resolution of a new advertiser and also to suggest a guide for setting of an appropriate budget.

The predicted charge amount calculating methods according to the above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

1. A method of providing a predicted charge amount of an advertisement corresponding to a keyword or keywords that an advertiser can purchase for keyword advertising, the method comprising:
calculating a first variable based on a standard deviation of daily charge amounts of an advertisement corresponding to each keyword and a maximum daily charge amount;
calculating a second variable based on the first variable, the standard deviation, and an average daily charge amount; and
calculating a predicted charge amount range based on the first variable and the second variable.

2. The method of claim 1, wherein the calculating of the first variable comprises:
calculating, for each keyword, a ratio of the standard deviation to the maximum daily charge amount; and
calculating the first variable by subtracting a ratio corresponding to the geometric mean of the calculated ratios from “1”.

3. The method of claim 2, wherein the calculating of the ratio of the standard deviation to the maximum daily charge amount comprises:
a first operation of calculating a standard deviation of daily charge amounts of an advertisement corresponding to a keyword;
a second operation of confirming a maximum daily charge amount among the daily charge amounts;
a third operation of calculating a ratio of the standard deviation to the maximum daily charge amount; and
a fourth operation of repeating the first operation through the third operation with respect to all the keywords.

4. The method of claim 1, wherein the calculating of the second variable comprises:
calculating, for each keyword, a ratio of the standard deviation to the average daily charge amount; and
calculating the second variable based on the geometric mean of the calculated ratios and the first variable.

5. The method of claim 4, wherein the calculating of the ratio of the standard deviation to the average daily charge amount comprises:
a first operation of calculating a standard deviation of daily charge amounts of an advertisement corresponding to a keyword;
a second operation of calculating an average daily charge amount of the daily charge amounts;
a third operation of calculating a ratio of the standard deviation to the average daily charge amount; and
a fourth operation of repeating the first operation through the third operation with respect to all the keywords.

6. The method of claim 1, wherein the calculating of the predicted charge amount range comprises:
calculating a minimum predicted charge amount based on the first variable and a daily charge amount range of the keyword; and
calculating a maximum predicted charge amount based on the second variable and the maximum daily charge amount of the keyword,
wherein the predicted charge amount range is determined based on the minimum predicted charge amount and the maximum predicted charge amount.

7. The method of claim 6, wherein:
the daily charge amount range is determined based on a minimum daily charge amount and a maximum daily charge amount among daily charge amounts of an advertisement corresponding to the keyword, and
the calculating of the minimum predicted charge amount comprises calculating, as the minimum predicted charge amount, a percentile value corresponding to the first variable in the daily charge amount range.

8. The method of claim 1, wherein the daily charge amount is calculated based on at least one of a quality index, a ranking index, the number of clicks, and a cost per click (CPC).

9. The method of claim 1, further comprising:
displaying the predicted charge amount range via an advertisement registration site.

10. A method of providing a predicted charge amount of an advertisement corresponding to a keyword or keywords that an advertiser can purchase for keyword advertising, the method comprising:
calculating a minimum predicted charge amount in a charge amount range of the previous day on the basis of a weight of a standard deviation of daily charge amounts of an advertisement corresponding to each keyword to a maximum daily charge amount of the daily charge amounts;
calculating a maximum predicted charge amount in the charge amount range of the previous day on the basis of a weight of the standard deviation to an average daily charge amount; and
determining, as a predicted charge amount range, a range by the minimum predicted charge amount and the maximum predicted charge amount.

11. The method of claim 10, wherein the calculating of the minimum predicted charge amount comprises:
calculating the weight of the standard deviation to the maximum daily charge amount on the basis of the maximum daily charge amount for each keyword and the standard deviation with respect to a distribution of daily charge amounts for each keyword; and
determining, as the minimum predicted charge amount, a percentile value corresponding to the weight of the standard deviation to the maximum daily charge amount in the charge amount range of the previous day.

12. The method of claim 11, wherein the calculating of the weight of the standard deviation to the maximum daily charge amount comprises:
calculating, for each keyword, the standard deviation of daily charge amounts of a corresponding advertisement;
confirming, for each keyword, the maximum daily charge amount among the daily charge amounts;
calculating ratios of the respective standard deviations to the respective maximum daily charge amounts; and
calculating, as the weight of the standard deviation to the maximum daily charge amount, a ratio by subtracting a ratio corresponding to the geometric mean of the calculated ratios from “1”.

13. The method of claim 10, wherein the calculating of the maximum predicted charge amount comprises:
calculating the weight of the standard deviation to the average daily charge amount based on the average daily charge amount for each keyword and the standard deviation of daily charge amounts for each keyword; and
calculating, as the maximum predicted charge amount, an operation result between a maximum charge amount in the charge amount range of the previous day and the weight of the standard deviation to the average daily charge amount.

14. The method of claim 13, wherein the calculating of the weight of the standard deviation to the average daily charge amount comprises:
calculating, for each keyword, the standard deviation of daily charge amounts of a corresponding advertising list;
confirming, for each keyword, the average daily charge amount among the daily charge amounts;
calculating ratios of the respective standard deviations to the respective average daily charge amounts; and
calculating the weight of the standard deviation to the average daily charge amount based on the weight of the standard deviation to the maximum daily charge amount and the calculated ratios.

15. A computer-readable recording medium storing a program for implementing the method of claim 1.

16. A system for providing a predicted charge amount of an advertisement corresponding to a keyword or keywords that an advertiser can purchase for keyword advertising, the system comprising:
a first variable calculating module to calculate a first variable based on a standard deviation of daily charge amounts of an advertisement corresponding to each keyword and a maximum daily charge amount of the daily charge amounts;
a second variable calculating module to calculate a second variable based on the first variable, the standard deviation, and an average daily charge amount; and
a predicted charge amount range calculating module to calculate a predicted charge amount range based on the first variable and the second variable.

17. The system of claim 16, wherein the first variable calculating module comprises:
a maximum daily charge amount ratio calculating module to calculate, for each keyword, a ratio of the standard deviation to the maximum daily charge amount; and
a remaining ratio calculating module to calculate, as the first variable, the remaining ratio excluding a ratio corresponding to the geometric mean of the calculated ratios from “1”.

18. The system of claim 16, wherein the second variable calculating module comprises:
an average daily charge amount ratio calculating module to calculate, for each keyword, a ratio of the standard deviation to the average daily charge amount; and
a calculating module to calculating the second variable based on the geometric mean of the calculated ratios and the first variable.

19. The system of claim 16, wherein the predicted charge amount range calculating module comprises:
a minimum predicted charge amount calculating module to calculate a minimum predicted charge amount based on the first variable and a daily charge amount range of the keyword; and
a maximum predicted charge amount calculating module to calculate a maximum predicted charge amount based on the second variable and the maximum daily charge amount of the keyword,
wherein the predicted charge amount range is determined based on the minimum predicted charge amount and the maximum predicted charge amount.

20. The system of claim 16, further comprising:
a display module to display the predicted charge amount range via an advertisement registration site.
